(19) United States
(12) Patent Application Publication
(10) Pub. No.: US 2009/0106792 A1
(43) Pub. Date: Apr. 23, 2009

(54) METHOD AND APPARATUS FOR ADVERTISEMENT AND CONTENT DISTRIBUTION WITH CUSTOMIZED COMMERCIAL INSERTION DURING CHANNEL CHANGE

(75) Inventors: CHAO KAN, FRISCO, TX (US); TIMUCIN OZUGUR, FAIRVIEW, TX (US)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: ALCATEL LUCENT, Paris (FR)

(21) Appl. No.: 11/876,110

(22) Filed: Oct. 22, 2007

(51) Int. Cl. H04N 7/08

(52) U.S. Cl. 725/34

(57) ABSTRACT

A method, system, and computer readable medium of inserting advertisement media content into an Internet Protocol Television (IPTV) system comprises providing media content to a user comprises receiving a first multicast stream containing a first media content at a set top box, displaying the first media content on a display, transmitting a unicast request from the set top box to a remote location in response to a television channel change operation, receiving a second multicast stream containing a second media content at the set top box in response to the unicast request, the second multicast stream including at least one I-frame, and displaying the second media content on the user's display in real-time in response to receiving the at least one I-frame.

### CROSS REFERENCE TO RELATED APPLICATIONS

The present patent application is related U.S. patent application Ser. No. 11/800,279, entitled IPTV ARCHITECTURE FOR DYNAMIC COMMERCIAL INSERTION filed with the U.S. Patent and Trademark Office on May 4, 2007, the entire contents of which are incorporated by reference herein.

### FIELD OF THE INVENTION

The present invention is related to fast channel change during targeted advertisement, and more particularly to fast channel change during advertisement and content distribution in Internet Protocol Television (IPTV) networks. In other embodiments, other networks can be utilized with the present invention.

### BACKGROUND OF THE INVENTION

Traditionally, targeted advertisement insertion in television networks includes delivering advertisements to a set top box (STB). The STB is a device that connects to a television and links to an external signal source, and which turns received signals into media content. The media content is then displayed on a television screen and is viewable by a user. In one conventional approach, multiple content streams are sent concurrently from a content source to the STB. The STB may also be used to tune into a channel carrying a target advertisement.

Advertisement insertion in traditional solutions is often based on a set of standards known as the Society of Cable Telecommunications Engineers, (SCTE) Nos. 35 and 30 signaling, which were developed for the cable TV industry. These solutions often provide limited advertisement/commercial, hereinafter ‘advertisement’ targeting capability. At best, conventional advertisement targeting is limited to a region not smaller than a city or a predetermined serving area. If targeted advertising is to be achieved on a finer scale (i.e., to a neighborhood or individual household), separate dedicated advertisement transmission is needed for each different advertisement stream.

To increase the precision of targeted advertisements various customized advertisements may be sent through different multicast streams, separate from the original main program stream. However, when a customer changes the channel and abandons the current stream of program content, one of two scenarios are possible.

First, if the customer changes from a first channel to a second channel showing a regularly scheduled television program, they should receive the content of that show without any unexpected delay. If, however, the customer changes the channel to a different channel, which shows a scheduled customized advertisement they are more likely to experience a blank screen. In fact, the user may be more likely to observe a blank screen for an increased period of time until the user's set top box is capable of joining an appropriate multicast tree while waiting for an I-frame and/or the video buffer to fill.

Following a channel change operation during a scheduled customized advertisement, the user may need to wait for a multicast join process to complete. In addition, the I-frame needs to arrive and the video buffer needs to be filled up to a certain threshold before a customized advertisement may be viewed. All of these factors may cause substantial delay for a customer waiting to view a television program.

### SUMMARY OF THE INVENTION

The present invention provides a system and method to provide fast channel change (or instant channel change) feature for customized advertisements, which allows the user to receive customized advertisement streams in real-time via unicast until a multicast join operation has completed.

An example embodiment of the present invention provides a method of providing customized commercial content to a user, the method comprising receiving a first multicast stream containing television show content at a set top box, providing the content to the user display allowing the user to view the content, transmitting a unicast request from the set top box to at least one of a first remote server and a second remote server in response to a television channel change operation, receiving one of a first content type unicast stream at the set top box if the unicast request was sent during a non-commercial time slot interval, and a second content type unicast stream at the set top box if the unicast request was sent during a commercial time slot interval, the received unicast stream including an I-frame, and displaying the content of the unicast stream on the user's display in real-time.

Another example embodiment of the present invention provides a method of providing customized advertisement content to a user during an allotted advertisement interval and after a channel change operation for a requested channel has occurred, the method comprising receiving a unicast request generated from a set top box of a user, determining the requested channel of the channel change operation is currently operating in an advertisement time slot interval, determining at least one customized advertisement stream that is designated to be delivered via a unicast stream to the requesting set top box based on user profile information of the user stored in memory, transmitting the at least one advertisement unicast stream designated to the requesting set top box, and displaying the media customized content of the unicast stream on the user's television in real-time in response to receiving an I-frame in the unicast stream.

Yet another example embodiment of the present invention provides a system of providing advertisement media content to a user during an allotted advertisement interval and after a channel change operation has occurred, the system includes a set top box configured to receive video streams containing media content, a first server configured to store and transmit at least one first stream to the set top box including a main media program, and a second server configured to store and transmit at least one second stream to the set top box including one customized advertisement media program via a unicast stream, where the first remote server sends the at least one first stream to the second remote server and the second remote server inspects the incoming stream to extract splicing information via one or more splicing marks in the stream, stores the splicing information including channel information associated with the splicing information, and where the second remote server also stores user profile information associated with the user to provide a designated advertisement to the user's set top box as a result of the channel change operation and based on the user profile information. In an alternate embodiment, the splicing information may be sent from an Ad splicer if less processing is desired.

Yet another example embodiment of the present invention provides a computer readable medium comprising instructions for forwarding customized advertisement media to a user via a unicast stream in response to a request from the user for customized content while viewing a channel which is in an advertisement interval state, wherein the customized content is requested from a remote server; requesting the user's set top box to join a designated multicast stream for the customized advertisement media; and sending a join message from the user's set top box to a second remote server to join the designated multicast stream of the customized advertisement media.

These and other advantages of the disclosed subject matter over the prior art will be readily apparent to one skilled in the art to which the disclosure pertains from a perusal of the claims, the appended drawings, and the following detailed description of the preferred embodiments.

### BRIEF DESCRIPTION OF THE DRAWINGS

FIG. 1 illustrates an IPTV advertisement insertion system;

FIG. 2 illustrates an IPTV advertisement insertion hierarchy system;

FIGS. 3-4 illustrate an IPTV architecture;

FIG. 5 illustrates another IPTV advertisement insertion hierarchy system;

FIG. 6 illustrates a splicing indicator table;

FIG. 7 illustrates a customer profile mapping table; and

FIG. 8 illustrates a flow diagram of processing an instant channel change operation.

### DETAILED DESCRIPTION OF THE INVENTION

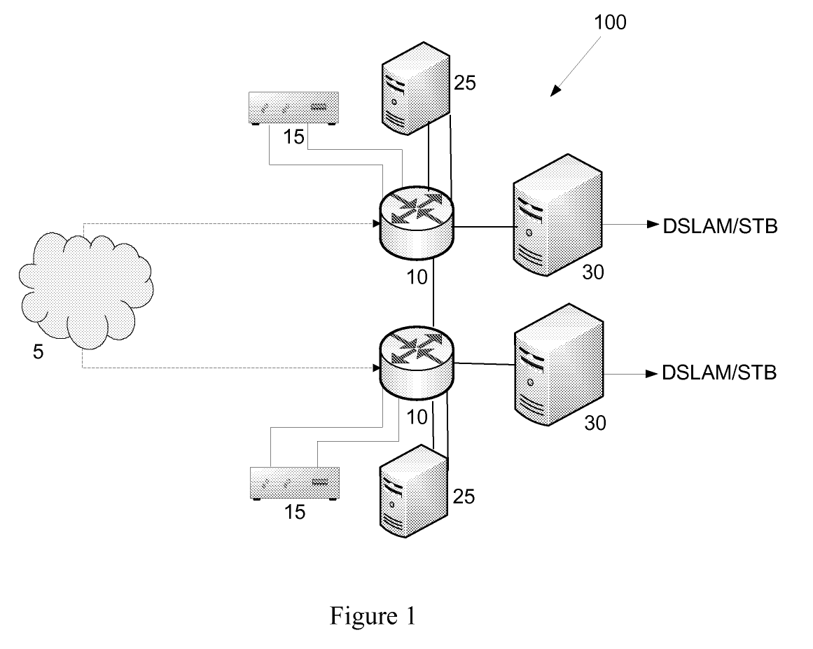

FIG. 1 illustrates an advertisement/commercial, hereinafter referred to as ‘advertisement’, insertion mechanism of an Internet protocol television (IPTV) system 100. The system 100 includes a backbone IP video network 5, and routers 10 coupled to the network 5, advertisement splicers 15, advertisement servers 25 and D-servers 30.

In operation, the IPTV system 100 receives and splices main program media content with advertisement media content. A main media program may be distributed through the backbone IPTV network 5 and forwarded through routers 10, where the main media program may be spliced via splicers 15, with advertisements received from the advertisements servers 25 and/or the D-servers 30. Once the splicing occurs, the advertisements may then be forwarded to the D-servers 30 which buffer and queue the advertisements for delivery to the lower end devices, such as, the digital subscriber line access multiplexers (DSLAM) and ultimately the STBs of the end user.

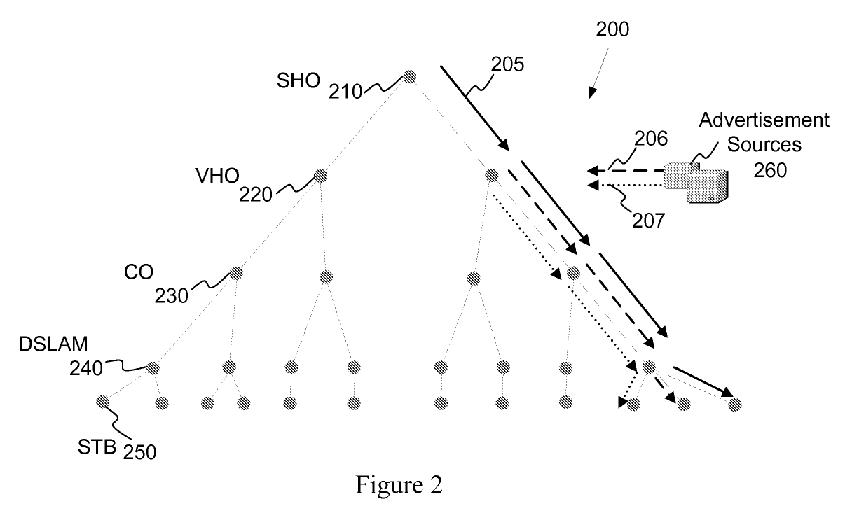

Referring to FIG. 2, the DSLAMs 240 refer to a network device often located at the PSTN and/or central office (CO) that connects multiple customer digital subscriber lines (DSL) to a high speed packet-switched network. The STBs 250 represent the individual end users that have a STB 250 installed in their homes and coupled to the DSLAM 240 to receive media content via a DSL or comparable subscriber line. The STBs 250 may be coupled directly to the customer's television sets to display the media content to the customer. The DSLAMs 240 may be coupled to a packet switched network, for example, Internet protocol (IP), Ethernet, asynchronous transfer mode (ATM), etc.

It is important to note that the network configuration of FIG. 1 is only an example IPTV system 100, and other configurations may having different variations of network components may also be suitable to perform the general functionality of the IPTV system 100. Therefore, various networking components may be added, substituted or omitted from the IPTV system 100 to accommodate varying networking conditions.

One approach to advertisement insertion, which may be used in the IPTV architecture 100 of FIG. 1, is to insert advertisements into the main media program through the use of the advertisement servers 25 and the advertisement splicers 15. The advertisement splicer 15 may use SCTE 35 and SCTE 30 signaling to combine the advertisement content from the advertisement servers 25 into the main media program stream based on splicing information.

The splicing information may be provided to the splicer 15 via in-band or out-of-band data transmissions. As a result of the splicing operation, the resulting multicast stream may have to go through the D-server 30, which provides added functionality, and delivery of the multicast stream to the DSLAM 240 and STB 250.

To achieve customized advertisements for different viewers, one approach is to send different advertisements through different multicast streams, separate from the original main media program multicast stream. The main media program stream and separate advertisement streams may be sent to the D-server 30 via separate multicast streams. The D-server 30 may be responsible for synchronizing and buffering the main media program multicast stream and one or more of the advertisement multicast streams.

FIG. 2 illustrates an example IPTV architecture hierarchy 200. The main media content, for example, a television program 205 is delivered to one or more end users A, B and/or C via a super hub office (SHO) 210. The SHO 210 may generally comprise one or more content acquisition systems that aggregate and distribute content for a large geographical region (i.e., nationwide).

Advertisement media content streams 206 and 207 may originate from one or more advertisements sources 260 and may be spliced with the main media content stream 205 and transmitted to the STBs 250 of the end users A, B and/or C. The advertisement media content streams 206 and 207 may be separate multicast streams, and may originate from the video hub office (VHO) 220 of the IPTV architecture hierarchy 200. A VHO 220 may represent content distribution on a regional scale to accommodate a demographic market area (e.g., town, city, county etc.).

The central offices (CO) 230 receive the content distribution of the VHOs 220. The COs 230 represent the content providers (e.g., cable, local access loop etc.), and are coupled to the digital subscriber line access multiplexers (DSLAM) 240. The DSLAMS 240 may be network devices located near the end user's location, and which operate by connecting multiple customer digital subscriber lines (DSL) to a high-speed Internet backbone line. The media content may be transmitted downstream via multicasting, unicasting etc. toward the DSLAM 240. The advertisement streams 206 and 207 may be inserted at the VHO 220, CO 230 and/or at the DSLAM 240 prior to being received at the STBs 250.

Inserting advertisements at lower levels of the IPTV architecture hierarchy 200 increases targeted advertising flexibility. Inserting or splicing advertisement streams 206 and 207 with the main media program 205 at the VHO 220, CO 230 and/or DSLAM 240 level may provide finer customized advertising. For example, assuming that user A and user B are watching the same media program stream 205, during an advertisement time slot interval the two users A and B could potentially view separate advertisements streams 206 and 207, respectively, and thus view different advertisements while watching the same television show.

In order to provide individual users with customized advertisements, the advertisement servers 25 will insert advertisements relevant to a set of user profiles. Multicast channels may be synchronized to single advertisement slots that accompany the main media program stream, as required by SCTE 35 signaling. The main media program stream will be empty during the duration of the advertisement. By configuration, profile, or other criteria, the SCTE 35 triggers the end device (i.e., STB 250) to join a particular multicast advertisement stream of interest. The multicast streams may be organized into groups and stored in a forwarding table.

A multicast forwarding table may be used to assign the advertisement multicast streams 206 and 207 to their respective end user customers ports. The STBs 250 at the end users A, B and/or C of FIG. 2 will treat the advertisement content 206 and 207, arriving in a separate multicast or unicast group, as belonging to the original program stream 205, and will decode and display the content accordingly. A variety of different content streams may be delivered to the DSLAM 240, and the STBs 250 may access some or all of the content based on end user preferences, which may be defined in the forwarding table of the DSLAM 240. The content provided to the STBs 250 will be decoded to appear as a single program (or a single aggregate channel) to the end user.

In one example, a third party controller (not shown) may be present to initiate or select and map an advertisement content stream to the STBs 250. In another example, the synchronizing of the advertisement streams 206 and 207 and the main media program stream 205 may occur at one or more of the advertisement servers 25, D-servers 30, splicers 15, DSLAMs 240, and the STBs 250 or a combination of at least two of these modules.

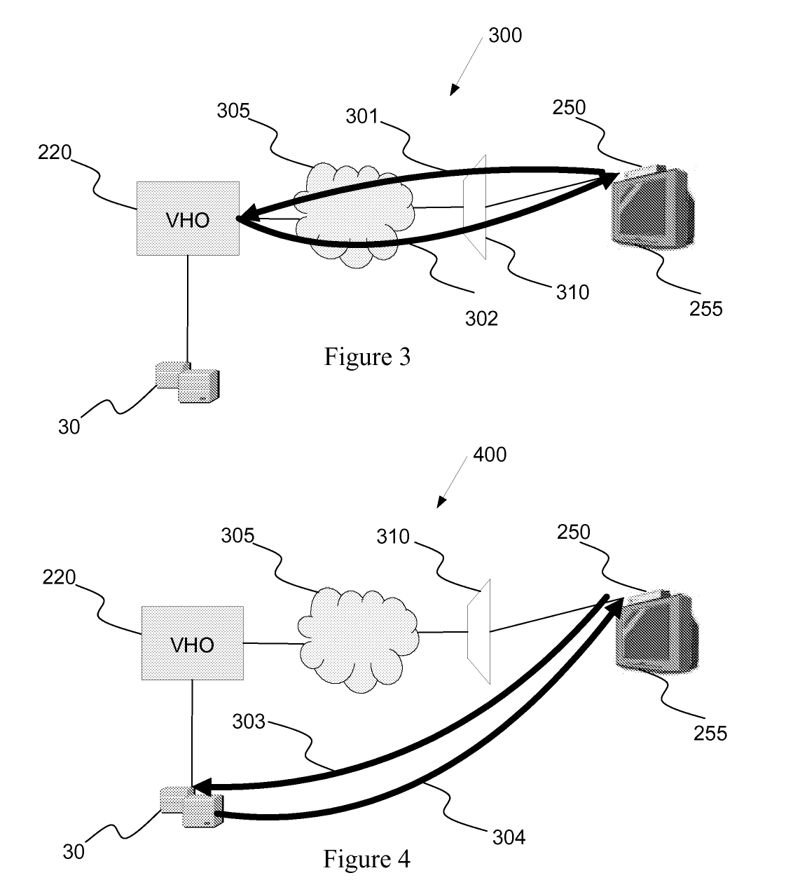

FIG. 3 illustrates an example IPTV architecture 300. Multicast streams of main media content are transmitted from a SHO (not shown) to a VHO 220. The main media content is transmitted through a regional transport network 305, which may contain any number and type of network components used to connect to the user end equipment. The DSLAMs (not shown) or Intelligent Service Access Manager (ISAM) 310 connect to the STB 250 and operate to receive and forward a multicast TV channel to the STB 250. The end user's STB 250 may communicate with the ISAM 310 via an IGMP client, which exchanges IGMP messages with the network in order to join a multicast group for a particular TV channel. The ISAM 310 may operate as an IGMP proxy to handle IGMP messages sent from the STB 250.

The STB 250 may receive media content via multicast streams transmitted from the SHO 210 and/or the VHO 220. To obtain media content, an IGMP join message 301 may be transmitted from the STB 250 to the ISAM 310 and through the regional transport network 305 to the VHO 220. As can be seen from FIG. 3, the IGMP join message 301 may be likely to experience network delay caused by one or more of the network elements in the IPTV communication path between the VHO 220 and the STB 250.

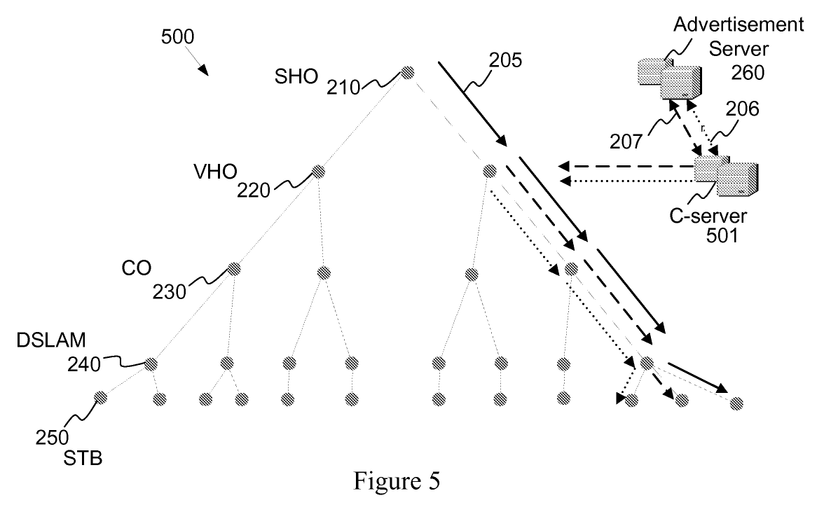

FIG. 4 illustrates an alternative to the IPTV architecture 300, which includes a transmission path of a HTTP request 303 transmitted from the STB 250. The HTTP request 303 may be a unicast transmission request to receive a unicast stream 304. The unicast stream 304 may contain I-frames used by the MPEG standard of IPTV. Once an I-frame is received the media content may be displayed to the user. The faster the I-frame is received at the STB the faster the media content may be viewed by the end user. The D-server 30 may contain additional functionality to expedite the HTTP unicast request, such as, as additional server (i.e., C-server), which is discussed in detail below with respect to FIGS. 5-8.

In IPTV, IP packets may encapsulate segments of MPEG-encoded video frames. Generally, MPEG streams contain three types of frames: I-frames, P-frames, and B-frames. An I-frame, or intra-coded picture reference frame, sends information about pixels in the frame. To reduce bandwidth, MPEG uses forward and reverse referencing to generate the forward-predicted P-frames and bidirectional-predicted B-frames from I-frames. That is, the P-frames and B-frames contain information about only those pixels that differ from previous and/or subsequent frames. During TV scenes with a relatively static background, such as when two people are standing in a room and talking, the P-frames and B-frames will vary only a little between frames. In a more dynamic scene, such as a horse race, nearly every pixel changes in every frame.

Providing customized advertisements to an intended end user may require additional planning to accommodate for different programming scenarios. For example, during an instant channel change (ICC) operation performed by the user, if the time slot of the channel being viewed by the user after the channel change operation occurs is a regularly scheduled program then the contents of the viewed channel should be viewable in real-time, in accordance with at least one of the example architectures described herein. If, on the other hand, the ICC operation occurs during an advertisement time slot, then the real-time delivery of the advertisement after the channel change operation has occurred may require additional processing and/or operational considerations.

Another important role for D-server 30 is to handle the Instant Channel Change (ICC) feature. When end viewers switch the channel, instead of sending IGMP join to a new multicast channel, which has a delay, the STB sends a unicast HTTP request to the D-server for immediate service. The D-server 30 then sends back the requested channel contents with important I-Frame as the first frame, at an accelerated speed also through unicast format. During the process, D-server also instructs the STB 250 to send an IGMP join message to the ISAM 310 to start and synchronize a content multicast stream.

The ICC function may be achieved through the D-server component 30, which stores the original main program multicast stream. However, as new advertisement multicast streams are generated for customized advertisement insertion, the amount of processing performed by the D-server may become increasingly complicated. Organizing various advertisement multicast and/or unicast streams, while proving real-time delivery is increasingly difficult to match when a user performs a channel change operation during a scheduled advertisement.

The unicast format may be used to send/respond to an instant channel change request without waiting for the time normally associated with a multicast IGMP join process. Since there are several different frames in the video stream and an I-frame is required before any of the frames can be displayed, the D-server 30 may cache and send the I-frame directly at the beginning of a request and at an accelerated speed.

ICC may allow the user to access content via unicast until a join message, such as, IGMP ‘join’ is complete. The user may then receive the content via multicast. ICC operates by forwarding the last I-frame in a sequence of content data frames first with bursting content from a cache via a unicast stream. This allows the content to be delivered to the user with increased speed. Without unicast and fast I-frame delivery, a user may experience delay, which may be due to delivery time for an I-frame and/or delay due to filling up a video buffer at the user's set top box. The content for a regular program may be cached at a D-server. The D-server may provide the content via unicast with the above enhancements during instant channel change.

Synchronizing and processing the advertisement content shortly after a channel change operation has occurred must be done in real-time to avoid displaying a blank screen to the end user. During an advertisement time slot interval, the main program may be considered null or blank and the one or more available advertisement streams may instead be provided to the end user.

One approach to handling the instant channel change operation advertisement processing, storage and synchronization is to add a new functional component to store the separate advertisement multicast streams at the Head End level. Assuming all advertisements are inserted at the Video Hub Office (VHO) 220, this component will consider the customized advertisement streams as regular multicast and/or unicast streams and buffer with I-frame caching when the splicing begins. Further, this component may also recycle the storage space when the commercial splicing completes.

For simplicity, this component will be called C-Server from now on to differentiate from the D-server 30 and the advertisement server 25. It needs to be pointed out that the functionality of the C-server may include a separate physical standalone server or, alternatively, may be a separate logical server embedded in the middleware or physical hardware of the D-server.

FIG. 5 illustrates an example IPTV architecture hierarchy 500. The IPTV architecture hierarchy 500 includes a C-server 501 coupled to the advertisement server 260. The advertisement server may represent one or more advertisement servers and/or a D-server 30 used to provide the media content to the end users. The C-server 501 may add a new processing mechanism including one or more content distribution algorithms and and/or associated channel based advertisement tables inside the C-server 501 to handle the instant channel flip request in the real-time for advertisement streams.

The C-server 501 may be responsible for synchronizing one or more advertisement multicast streams received through the advertisement server 260. The C-server 501 may also assist in providing regular program media content and/or advertisements to end users transparently and without interruption while optimizing existing IPTV architectures.

Referring to FIG. 5, when a splicing operation begins, one or more advertisement multicast and/or unicast streams 206 and 207 may be inserted into allocated time slots intermittent to the regularly scheduled program. The advertisement multicast streams 206 and 207 may also be forwarded to the C-server 501 at the beginning of the splicing operation, which buffers the multicast streams. The advertisement multicast streams 206 and 207 may also be forwarded to the C-server 501 prior to a splicing operation to allow more time for buffering and I-frame insertion caching operations to mature prior to advertisement time slots.

In one example, the C-server 501 may implement I-frame caching schemes by adding one or more I-frames to the received multicast streams. However, different from the D-server 30 functionality, where continuous buffering may be required to keep up with incoming/outgoing multicast and/or unicast streams, the C-server 501 may recycle storage space between splicing operations. The C-server 501 may also start and stop the buffering process when the commercial splicing starts/completes to save resources and processing power.

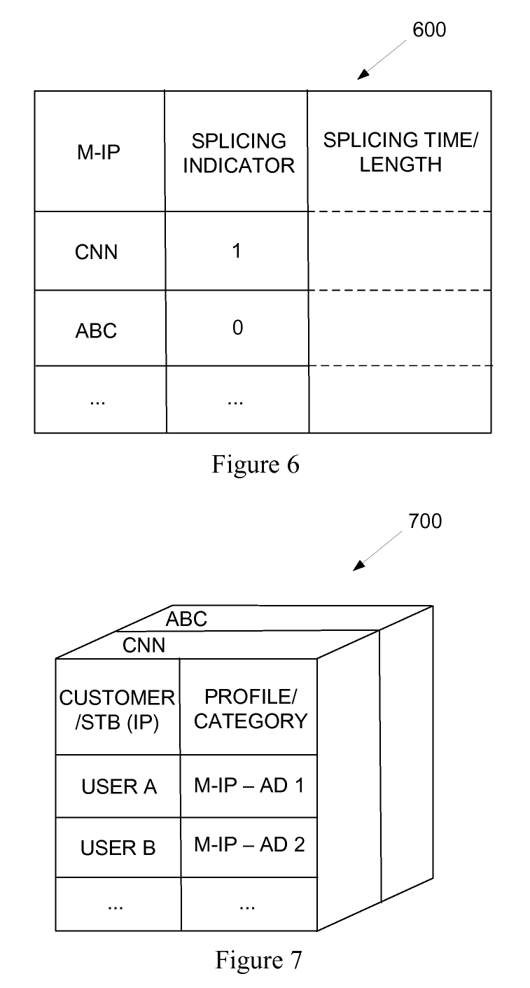

FIG. 6 illustrates a splicing indicator table 600 which may be stored at the C-server 501 to keep a record of the splicing information of the incoming media content data. In operation, the C-server 501 may inspect the incoming packets, and extract splicing information through an element stream (ES) splicing mark or other comparable method. The C-server 501 may also have to record the splicing time and length, and track and update the table 600 as indicated by the dotted line column. The channels viewed by the user will have corresponding splicing information (e.g., CNN, ABC etc.) available in the multicast and/or unicast streams of their respective content streams. The table 600 may require updates in real-time to keep up with the demand for splicing information. In an alternate embodiment, the splicing information may be sent from an Ad splicer if less processing is desired.

The C-server 501 may also be responsible for maintaining a customer profile mapping table 700. Referring to FIG. 7 The profile mapping table 700 maps the end viewer's profile with corresponding specific advertisement multicast streams. The C-server 501 may use the profile information to map specific end users to the correct customized advertisements during the advertisement time slots so that different ICC operation requests may be responded to with the correct advertisement multicast stream(s). Depending on the preferred configuration, the profile mapping table 700 may be channel based and/or profile based across different channels.

To obtain the channel-based customer profile mapping table of FIG. 7, the C-server 501 may need to communicate with the D-server 30 since this information may have already been available in the D-server 30. From an implementation perspective, the C-server 501 may be implemented either as a standalone server or embedded into the D-server 30.

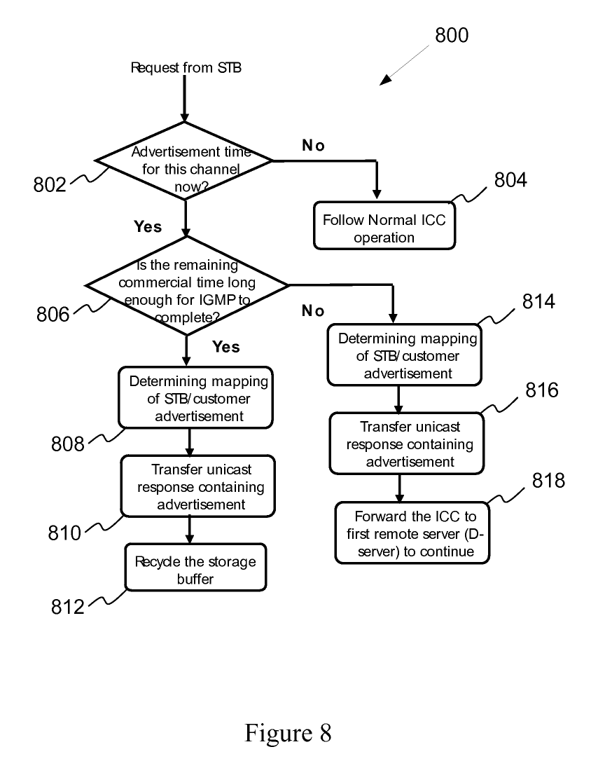

FIG. 8 illustrates an example processing procedure 800 to handle an instant channel change (ICC) operation. Assuming a user changes the channel on the STB/TV, a request (i.e., HTTP request) will be generated from the STB and transferred to one or more of the D-server 30, the advertisement server 25 and the C-server 501. Upon receiving the request from the STB, the C-server 501 processing function will check whether the requested channel is currently in an advertisement time slot by checking the timing information in the request (operation 802). The request may be a unicast request or other type of broadcast format. The C-server 501 performs the lookup by referencing the multicast and/or unicast channel splicing indicator table 600 of FIG. 6. If the underlying channel is not in an advertisement mode then the C-server 501 may hand the process to the D-server 30 to handle a regular ICC operation (operation 804). If the channel is in an advertisement mode the C-server 501 processing function will check if any remaining commercial time is long enough for the IGMP to complete (operation 806).

If the remaining commercial time is long enough for the IGMP to complete, the C-server 501 will examine the customer profile mapping table of FIG. 7 to determine the corresponding advertisement multicast streams that need to be delivered to the user based on what channel is requested or other matching information used in the profile matching table 700 (operation 808). Then the C-server 501 follows the process similar to the D-server 30 ICC and sends the stored advertisement contents to the STB 250 through a unicast data burst stream, and in some instances at an accelerated speed (operation 810). During the unicast transmission, the C-server 501 may also instruct the STB 250 to initiate the IGMP “join” process to the multicast stream. After the commercial time completes, the C-server 501 may select to recycle the storage buffer and/or stop the buffering process (operation 812).

If the channel is in the advertisement mode the C-server 501 processing function will check if any remaining commercial time is long enough for the IGMP to complete (operation 806). If the remaining commercial time is not long enough for the IGMP to complete, the C-server 501 will examine the customer profile mapping table of FIG. 7 to determine the corresponding advertisement multicast streams that need to be delivered to the user based on what channel is requested or other matching information used in the profile matching table 700 (operation 814). Then the C-server 501 follows the process similar to the D-server 30 ICC and sends the stored advertisement contents to the STB 250 through a unicast data burst stream, and in some instances at an accelerated speed (operation 816). During the unicast transmission, the C-server 501 may also instruct the STB 250 to initiate the IGMP “join” process to the multicast stream. After the commercial time completes, the C-server 501 forwards the ICC to the first remote server (the D-server 30)to continue processing (operation 818).

The C-server 501 processing mechanism on ICC requests may provide a smoother switchover between multicast streams of main media programs and customized media advertisements during advertisement time intervals. Service providers may recognize increased earning potential by having the flexibility to offer customized advertisements at the user-to-user level. The change in content is transparent to end viewers, which would require no new user behavior. In another example, no splicing information or SCTE 35 signaling is required for the STB 250. Further, no new protocols would be required and the system may be implemented using existing protocols that are transparent to network transport equipment.

An IPTV system may deploy any network based customized ad insertion, including multicasting ad insertion techniques or other types of unicast based customized advertisement insertion. According to one or more embodiments described herein, instant (or fast) channel change (ICC) for customized advertisement does not depend on which network based advertisment insertion technique is deployed in the system unless it is a non-real time STB based advertisement insertion, which does not rely on the network for fast channel change during advertisments.

The present invention provides advertisement and customized content distribution in IPTV networks. In one embodiment of the present invention, a method of providing media customized content to a user comprises receiving a first multicast stream containing a first media customized content at a set top box, displaying the first media customized content on a display, transmitting a unicast request from the set top box to a remote location in response to a television channel change operation, receiving a unicast stream containing a second media customized content at the set top box in response to the unicast request, the second multicast stream including an I-frame, and displaying the second media customized content on the user's display in real-time in response to receiving the I-frame.

Within the method, the first multicast stream is received at the set-top box and the unicast request is sent from the set-top box to at least one of the first remote server and the second remote server, wherein the first media customized content is a television program show and the second media customized content is an advertisement customized for the user, wherein the unicast stream is buffered and cached with at least one I-frame, wherein the channel change operation occurs during the viewing of the unicast stream, and the I-frame is received at the set top box prior to any other data frames of the unicast stream, and wherein the set top box sends an IGMP join request in response to the channel change operation.

In another embodiment of the present invention, a method of providing advertisement media customized content to a user during an allotted advertisement interval and after a channel change operation has occurred comprises: receiving a request generated from a set top box of a user at a remote server, determining the requested channel is currently operating in an advertisement time slot interval, determining at least one customized advertisement stream that is designated to be delivered to the requesting set top box based on user profile information of the user stored in memory, transmitting the at least on advertisement unicast stream designated to the requesting set top box, and displaying the media customized content of the unicast stream on the user's television in real-time in response to receiving an I-frame in the unicast stream.

Within the method, the remote server receives the advertisement unicast stream during a splicing operation performed by a second remote server, and performs an I-frame caching scheme on the received advertisement unicast stream, wherein determining the requested channel is currently operating in an advertisement time interval slot is performed by a look-up operation that references a splicing indicator table stored in memory at the remote server, and where the splicing indicator table includes information regarding the splicing history of one or more channels viewed by the user, wherein determining at least one advertisement unicast stream that is designated to be delivered to the requesting set top box based on user profile information stored in the memory of the remote server is performed by a look-up operation that references a user profile mapping table stored in memory at the remote server, and where the profile mapping table includes information regarding the user of the set top box and their respective assigned advertisements for the corresponding channel being viewed, wherein the request transmitted from the set top box is a unicast HTTP type request, wherein the advertisement is transmitted from the remote server via a unicast burst stream format and includes at least on I-frame generated at the remote server, wherein a unicast HTTP type request and an IGMP join message are both sent from the set top box as a result of the instant channel change operation, and wherein the storage space of the advertisement at the remote server is recycled after the allotted advertisement slot for this advertisement has ended.

In a further embodiment of the present invention, a system of providing advertisement media customized content to a user during an allotted advertisement interval and after a channel change operation has occurred comprises: a set top box configured to receive video streams containing media customized content, a first server configured to store and transmit at least one first stream to the set top box including a main media program, and a second server configured to store and transmit at least one second stream to the set top box including at least one advertisement media program via unicast, wherein the first server sends the at least one first stream to the second server and the second server inspects the incoming stream to extract splicing information via one or more splicing marks in the stream, stores the splicing information including channel information associated with the splicing information, and where the second server also stores user profile information associated with the user of the set top box to provide a designated advertisement to the user's set top box as a result of the channel change operation and based on the user profile information.

The system further comprises an IGMP proxy for receiving an IGMP request sent from the set top box as a result of the channel change operation, and a television coupled to the set top box for displaying the designated advertisement received from the second server.

In yet another embodiment a method of providing advertisement media customized content to a user during an allotted advertisement interval and after a channel change operation has occurred, the system comprises: requesting customized content from a remote server, forwarding customized advertisement media to a user via unicast in response to a user request for customized content while viewing a channel which is in an advertisement interval state, requesting the user's set top box to join the designated multicast stream for the customized advertisement, and sending a join message from the user's set top box to a second remote server to join the designated multicast stream of the customized advertisement media.

The described and depicted modules or processes with reference to FIGS. 1-8 are composed of at least one of: software, hardware, and firmware, and/or the combination of at least two of the same. The transfer of data between the various modules may occur via at least one of a wireless protocol, a wired protocol, and a combination of a wireless protocol and a wired protocol.

While preferred embodiments of the present invention have been described, it is to be understood that the embodiments described are illustrative only and the scope of the invention is to be defined solely by the appended claims when considered with a full range of equivalents and modifications (e.g., protocols, hardware devices, software platforms etc.) thereto.

What is claimed is:

1. A method of providing customized commercial content to a user, the method comprising:
receiving a first multicast stream containing television show content at a set top box; providing the content to the user display allowing the user to view the content;
transmitting a unicast request from the set top box to at least one of a first remote server and a second remote server in response to a television channel change operation;
receiving one of a first content type unicast stream at the set top box if the unicast request was sent during a non-commercial time slot interval, and a second content type unicast stream at the set top box if the unicast request was sent during a commercial time slot interval, the received unicast stream including an I-frame; and
displaying the content of the unicast stream on the user's display in real-time.

2. The method of claim 1, wherein the first content type is a television program show.

3. The method of claim 1, wherein the second content type is a customized commercial customized for the end user.

4. The method of claim 1, wherein the first content type time interval is based on the content of the changed to channel.

5. The method of claim 1, wherein the first and second remote servers are physically separate servers.

6. The method of claim 1, wherein the second remote server is embedded in the first remote server and the first and second servers are the same physical server.

7. The method of claim 1, wherein the unicast stream is buffered and cached with the I-frame.

8. The method of claim 1, wherein the I-frame is received at the set top box prior to any other data frames of the unicast stream.

9. The method of claim 1, wherein the set top box sends an IGMP join request in response to the channel change operation.

10. The method of claim 1, wherein the second remote server receives the unicast request and checks current timing information to determine if the changed to channel is operating in the commercial time slot interval, and if so, mapping the requester profile to the customized commercial content and delivering the customized commercial content to the requester, and alternatively, if the changed to channel is not operating in the commercial time slot interval, forwarding the unicast request to the first remote server which delivers the television program show to the requester.

11. A method of providing customized advertisement content to a user during an allotted advertisement interval and after a channel change operation for a requested channel has occurred, the method comprising:
receiving a unicast request generated from a set top box of a user;
determining the requested channel of the channel change operation is currently operating in an advertisement time slot interval;
determining at least one customized advertisement stream that is designated to be delivered via a unicast stream to the requesting set top box based on user profile information of the user stored in memory;
transmitting the at least one advertisement unicast stream designated to the requesting set top box; and
displaying the media customized content of the unicast stream on the user's television in real-time in response to receiving an I-frame in the unicast stream.

12. The method of claim 11, wherein a remote server receives the advertisement unicast stream during a splicing operation performed by a second remote server, and performs an I-frame caching scheme on the received advertisement unicast stream.

13. The method of claim 11, wherein determining the requested channel is currently operating in an advertisement time interval slot is performed by a look-up operation that references a splicing indicator table stored in memory at the remote server, and where the splicing indicator table includes information regarding the splicing history of one or more channels viewed by the user.

14. The method of claim 11, wherein determining at least one advertisement multicast stream that is designated to be delivered to the requesting set top box based on profile information of the set top box stored in the memory of the remote server is performed by a look-up operation that references a user profile mapping table stored in memory at the remote server, and where the profile mapping table includes information regarding the user of the set top box and their respective assigned advertisements for the corresponding channel being viewed.

15. The method of claim 11, wherein the request transmitted from the set top box is a unicast HTTP type request.

16. The method of claim 11, wherein the advertisement is transmitted from the remote server via a unicast burst stream format and includes at least on I-frame generated at the remote server.

17. The method of claim 11, wherein a unicast HTTP type request and an IGMP join message are both sent from the set top box as a result of the instant channel change operation.

18. The method of claim 11, wherein the storage space of the advertisement at the remote server is recycled after the allotted advertisement slot for this advertisement has ended.

19. A system of providing advertisement media customized content to a user during an allotted advertisement interval and after a channel change operation has occurred, the system comprising:
a set top box configured to receive video streams containing media customized content;
a first server configured to store and transmit at least one first stream to the set top box including a main media program; and
a second server configured to store and transmit at least one second stream to the set top box including at least one advertisement media program via unicast; wherein the first server sends the at least one first stream to the second server and the second server inspects the incoming first stream to extract splicing information via one or more splicing marks in the first stream, stores the splicing information including channel information associated with the splicing information, and where the second server also stores user profile information associated with the user to provide a designated advertisement to the user's set top box as a result of the channel change operation and based on the user profile information.

20. The system of claim 19, further comprising an IGMP proxy for receiving an IGMP request sent from the set top box as a result of the channel change operation.

21. The system of claim 19, further comprising a television coupled to the set top box for displaying the designated advertisement received from the second remote server.
